(19) United States
(12) Patent Application Publication
(10) Pub. No.: US 2025/0054074 A1
(43) Pub. Date: Feb. 13, 2025

(54) METHOD AND SYSTEM FOR DETERMINING THE ROBUSTNESS OF A MINE PLAN

(71) Applicant: BHP INNOVATION PTY LTD, Melbourne (AU)

(72) Inventors: Russell Seib, Melbourne (AU); Andrew Wells, Brisbane (AU); Sam Patterson, Highgate Hill (AU)

(21) Appl. No.: 18/722,704

(22) PCT Filed: Dec. 22, 2022
(86) PCT No.: PCT/AU2022/051557

§ 371 Date: Jun. 21, 2024

(30) Foreign Application Priority Data
Dec. 22, 2021 (AU) 2021904202

(51) Int. Cl. G06Q 50/02; G06Q 10/0637; G06Q 10/067

(52) U.S. Cl. CPC G06Q 50/02; G06Q 10/0637; G06Q 10/067

(57) ABSTRACT

A computer implemented method for determining the robustness of a mine plan, the method comprising computer program code instructions, being executable by a computer for replicating a mine plan, the mine plan including one or more tasks required to perform operations in a mine; grouping the one or more tasks into one or more work packages, each work package being associated with a duration of time; determining, for the one or more work packages, a variance associated with the duration of time; applying the variance based on at least one simulation to generate a float, the float being the duration of time between the completion of a precedent work package and/or the commencement of a subsequent work package; consolidating each float from the at least one simulation into a robustness index; and displaying at least a portion of the robustness index to a user via a graphical user interface.

### TECHNICAL FIELD

The invention relates to a method and system for determining the robustness of a mine plan.

### BACKGROUND OF INVENTION

Mine plans define a set of tasks required to perform operations in a mine. For example, production targets in a mine may specify the quantity and quality of material that must be shipped on a monthly, weekly, and daily schedule. Given these targets, mining engineers allocate resources including mine personnel, shovels, excavators, drills etc. and determine a sequence in which to mine the reserve.

Mine plans are generally deterministic using single point assumptions and inputs resulting in a single output. For example, the mine plan will take a task such as truck shovel waste removal for a block or strip and determine how long it will take to complete mining that task using a set of inputs. Typically, no variation is applied to the inputs.

The mine planning process is undertaken over a wide range of timeframes (e.g., life of asset, five years, 2 years, <1 year), at every mine and at regular intervals (e.g., triennial, annual, monthly). For every mine plan that is published, multiple options are assessed, and numerous iterations of that mine plan are undertaken in the planning stages. Currently there is no tool that allows comparison of the robustness between plan iterations. That is, there is no tool to assess the ability of a mine plan to withstand variability of inputs which occur within the period of the plan.

Generally, a mine plan is based on key inputs including resources (e.g. shovel, drills, etc), tasks, rates, and time. In a single mine plan, there are usually thousands of individual tasks, and the sequence of those tasks, including the equipment allocated to those tasks, is the focus of scheduling optimisation and proprietary mine planning software. The schedule optimisation sequences the tasks (e.g., quantities) based on equipment which operate under sequence and time constraints and planned equipment rates. The focus of optimisation is to achieve the sequence that provides the most desirable and profitable use of resources and the deposit.

The mine plan determines the economic outcome of each mine. As a sector, mine plans are presented with headline metrics, e.g., tonnes per annum, average yield, strip ratio etc. However, mine plans do not include, or are not presented by reference to, any metrics that predict the likelihood of whether the mine plan is achievable.

Often variation is considered to be linked with poor performance (e.g., rate and time) but this is only one of many causes of variation that impact the mine plan. There is inherent known variance in the key mine plan inputs of task, rate and time that are usually not considered in the mine plan.

It would be desirable to provide a method and system for determining the robustness of a mine plan by applying variance to key inputs and having an object and repeatable way of measuring the impact on the proposed plan.

It would also be desirable to provide a single robustness index for a given mine plan that highlights material risks and, likewise, opportunities for reducing buffers in the plan (removing excess float).

A reference herein to a patent document or other matter which is given as prior art is not to be taken as an admission or a suggestion that the document or matter was known or that the information it contains was part of the common general knowledge as at the priority date of any of the claims.

### SUMMARY OF INVENTION

According to an aspect of the present invention, there is provided a computer implemented method for determining the robustness of a mine plan, the method comprising computer program code instructions, being executable by a computer for: replicating a mine plan, the mine plan including one or more tasks required to perform operations in a mine; grouping the one or more tasks into one or more work packages, each work package being associated with a duration of time; determining, for the one or more work packages, a variance associated with the duration of time; applying the variance based on at least one simulation to generate a float, the float being the duration of time between the completion of a precedent work package and/or the commencement of a subsequent work package; consolidating each float from the at least one simulation into a robustness index; and displaying at least a portion of the robustness index to a user via a graphical user interface. Each work package may consist of tasks that are intrinsic to themselves. For example, not impacting on other processes. Advantageously, where a schedule is measured or assessed for robustness a trade-off between the risk and return can be better understood. This understanding can be used to assess and compare schedules, iterations, or multiple schedules from various sources. Additionally, in this particular form of the invention, a user can readily compare the robustness between iterations of a mine plan. As will be appreciated, multiple options are assessed and a number of iterations of the mine plan are undertaken in the planning stages of a mine. The mine planning process is undertaken over a wide range of timeframes, at every mine and at regular intervals. Furthermore, if the invention is applied consistently across mining operations, it is possible to compare the robustness of mine plans from different operations, indeed, in different commodities and mining methods, in an objective and repeatable manner, providing decision makers with metrics to better understand the “deliverability” of promised production levels and guide better investment decisions.

In one or more embodiments, at least one simulation includes at least one of a discrete event simulation, dynamic simulation, or Monte Carlo simulation. Additionally or alternatively, other variants of sampling in probabilistic simulation, such as Latin hypercube, and Sobol sampling, importance sampling or any variance reduction techniques commonly employed with or as a substitute for traditional Monte Carlo sampling may also be used.

In one or more embodiments, the variance is derived from at least one of historical data, geostatistical data, geostatistical data from a geological model, reconciliation data, or input by the user. The variance may be considered as a resource confidence category used to define a geological model based on low, medium and high levels of confidence. These confidence levels may be related to how confident a geologist is with the level of exploration and to what extent statistics have been used to calculate the quantity or quality. The lower the confidence level, the more variance there may be between the model and reality.

In one or more embodiments, the variance is expressed as a probability density function. The variance may also be expressed as a cumulative distribution function or a similar probability-related function.

In one or more embodiments, grouping the one or more tasks into one or more work packages is based on at least one of a common resource, location, or process in the mine. Advantageously, grouping the tasks into work packages improves the overall performance of the system measured in terms of throughput, speed and response time. System resources may also be released for other tasks, which improves scalability and results in consistent optimal performance. This process also forms the basis for automation of the scheduling process in future developments. Additionally, it eliminates non-meaningful interactions and provides focus on the critical interfaces within the plan.

In one or more embodiments, the method further comprises the step of including one or more unscheduled tasks between the precedent and/or subsequent work packages. Advantageously, this allows for unscheduled tasks and inventory rules to be captured and the unvaried schedule float between tasks to be measured. Advantageously, this may form the foundation for future mine scheduling automation as it provides finer granularity on resource requirements for mining process that are often estimated using broad-brush calculations rather than specific allocation of resources to a task that may lead to gross underestimation of requirements to deliver the plan (e.g., average drill requirement is for two drills in a month, but peak load requires four drills at a specific drill location for three weeks of the month).

In one or more embodiments, the float is the duration of time between the completion of a precedent work package and the commencement of a subsequent work package less the duration of time of the one or more unscheduled tasks.

In one or more embodiments, the float is displayed to the user as an integer. A single metric of robustness allows simple consolidation and representation of data and comparison of plans and plan iterations.

According to an aspect of the present invention, there is provided a system for determining the robustness of a mine plan, the system comprising: a processor configured to at least: replicate a mine plan, the mine plan including one or more tasks required to perform operations in a mine; group the one or more tasks into one or more work packages, each work package being associated with a duration of time; determine, for the one or more work packages, a variance associated with the duration of time; apply the variance based on at least one simulation to generate a float, the float being the duration of time between the completion of a precedent work package and/or the commencement of a subsequent work package; consolidate each float from the at least one simulation into a robustness index; and display at least a portion of the robustness index to a user via a graphical user interface, with the ability to provide spatial and temporal “hot spots” where the plan is identified as not being robust.

In one or more embodiments, the at least one simulation includes at least one of a discrete event simulation, dynamic simulation, or Monte Carlo simulation.

In one or more embodiments, the variance is derived from at least one of historical data, geostatistical data, geostatistical data from a geological model, reconciliation data, or input by the user.

In one or more embodiments, the variance is expressed as a probability density function.

In one or more embodiments, the processor groups the tasks into one or more work packages based on at least one of a common resource, location, or process in the mine.

In one or more embodiments, the processor includes unscheduled tasks between the precedent and subsequent work packages.

In one or more embodiments, the float is the duration of time between the completion of a precedent work package and the commencement of a subsequent work package less the duration of the one or more unscheduled tasks.

In one or more embodiments, at least a portion of the float is displayed to the user as a band representing at least one of minor, moderate, or major risk associated with the execution of the mine plan.

In one or more embodiments, the float is displayed to the user as an integer.

According to an aspect of the present invention, there is provided a computer implemented method for determining the robustness of a mine plan, the method comprising computer program code instructions, being executable by a computer for: replicating a mine plan, the mine plan including a set of tasks required to perform operations in a mine; parsing the mine plan into one or more activities involving the movement of an inventory mass between one or more nodes in the mine; determining, for one or more activities, a variance associated with one or more of the quality, quantity, rate and time; apply the variance based on at least one simulation to generate a float, the float being the inventory mass between the nodes; consolidating each float from the at least one simulation into a robustness index; and displaying at least a portion of the robustness index to a user via a graphical user interface.

In one or more embodiments, the at least one simulation includes at least one of a discrete event simulation, dynamic simulation, or Monte Carlo simulation.

In one or more embodiments, the variance is derived from at least one of historical data, geostatistical data, geostatistical data from a geological model, reconciliation data, or input by the user.

In one or more embodiments, the variance is expressed as a probability density function.

In one or more embodiments, the float is displayed to the user as a band representing at least one of minor, moderate, or major risk associated with the execution of the mine plan.

In one or more embodiments, the float is displayed to the user as an integer.

According to an aspect of the present invention, there is provided a system for determining the robustness of a mine plan, the system comprising: a processor configured to at least: replicate a mine plan, the mine plan including a set of tasks required to perform operations in a mine; process the mine plan into one or more activities involving the movement of an inventory mass between one or more nodes in the mine; determine, for one or more activities, a variance associated with one or more of the quality, quantity, rate and time; apply the variance based on at least one simulation to generate a float, the float being the inventory mass between the nodes; consolidate each float from the at least one simulation into a robustness index; and display at least a portion of the robustness index to a user via a graphical user interface.

In one or more embodiments, the at least one simulation includes at least one of a discrete event simulation, dynamic simulation, or Monte Carlo simulation.

In one or more embodiments, the variance is derived from at least one of historical data, geostatistical data, geostatistical data from a geological model, reconciliation data, or input by the user.

In one or more embodiments, the variance is expressed as a probability density function.

In one or more embodiments, the float is displayed to the user as a band representing at least one of minor, moderate, or major risk associated with the execution of the mine plan.

In one or more embodiments, the float is displayed to the user as an integer.

### BRIEF DESCRIPTION OF DRAWINGS

The invention will now be described in further detail by reference to the accompanying drawings. It is to be understood that the particularity of the drawings does not superseded the generality of the preceding description of the invention.

FIG. 1a shows a diagram of a first model, ‘Model A’, in accordance with an embodiment of the present invention;

FIG. 1b shows a diagram of a second model, ‘Model B’, in accordance with an embodiment of the present invention;

FIG. 2 shows a simplified block diagram of a robustness assessment system in accordance with an embodiment of the present invention;

FIG. 3 shows a grouping of scheduled tasks into work packages in accordance with an embodiment of the present invention;

FIG. 4 is a flowchart of a method for determining an appropriate work package in accordance with an embodiment of the present invention;

FIG. 5a is a sample table of one or more work packages in accordance with an embodiment of the present invention;

FIG. 5b is a sample table of one or more work packages in accordance with an embodiment of the present invention;

FIG. 5c is a sample table of one or more work packages in accordance with an embodiment of the present invention;

FIG. 6 shows a block diagram of a replication module that forms part of a robustness assessment system in accordance with an embodiment of the present invention;

FIG. 7 shows a diagram of variance associated with the duration of time being applied between work packages in accordance with an embodiment of the present invention;

FIG. 8 shows a cause tree illustrating how a user may view or select what elements of the variance architecture will be included in the stochastic simulation in accordance with an embodiment of the present invention; and

FIG. 9 is a flow chart of a method for determining the robustness of a mine plan in accordance with an embodiment of the present invention.

### DETAILED DESCRIPTION

The invention is suitable for determining the robustness of a mine plan, and it will be convenient to describe the invention in relation to that exemplary, but non-limiting, application. However, it will be appreciated that the same approach is applicable to exploration plans, maintenance plans, construction plans, processing plans and the like.

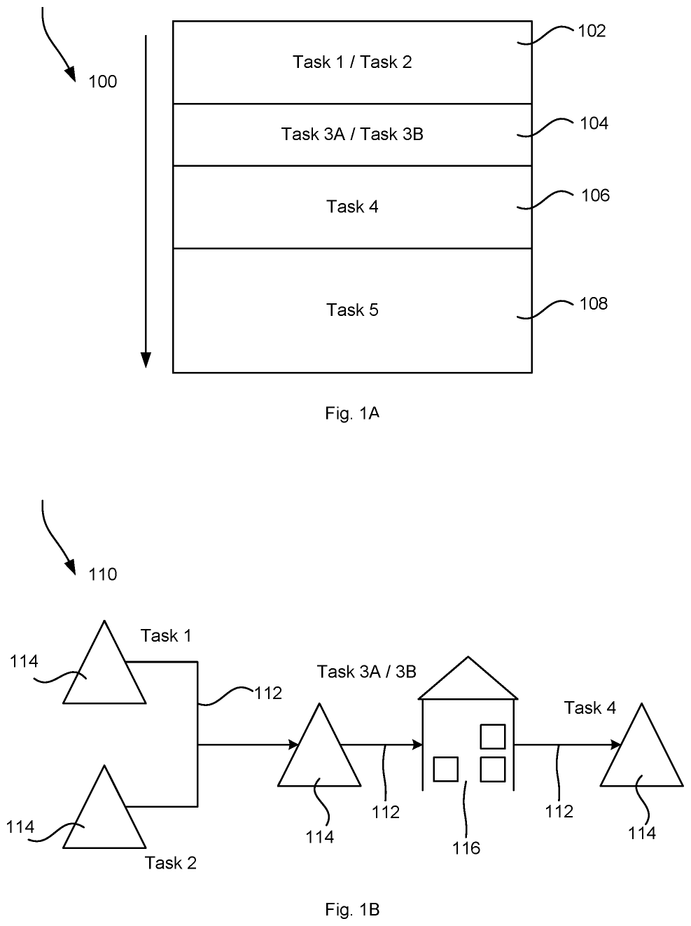

FIG. 1a shows a diagram of a first model 100, herein referred to as ‘Model A’, used for determining the robustness of a mine plan according to an embodiment of the present invention. The model 100 defines the functional requirements for the robustness assessment of the mine plan. In simple terms, a mine plan includes a list of tasks required to perform operations in a mine.

Model A 100 is used where there are spatial relationships between precedent tasks 102 and subsequent tasks 104 such as the: drilling of prestrip overburden; removal of prestrip overburden; drilling of dragline overburden; removal of dragline overburden fragmentation of coal; mining of coal and the like.

The resources to be used for each task 102, 104, 106 and 108 are competing for the same space and require completion of a precedent task 102 before a subsequent task 104, 106, 108 can commence. Float for Model A is measured as time i.e., time between the precedent 102 and subsequent tasks 104, 106, 108.

FIG. 1b shows a diagram of a second model 110, herein referred to as ‘Model B’, used for determining the robustness of a mine plan according to an embodiment of the present invention.

Model B 110 is used to model a flow 112 of material between points or nodes, represented by triangles 114. Subsequent tasks are dependent on sufficient inventory 116. The measure of float for Model B is closing inventory. For example, the flow of coal is from a node to various run of mine (ROM) and or crushed coal stockpiles then fed to the coal handling and preparation plant CHPP (not shown) and onto the product stockpile. In this case the nodes 114 would be input, ROM stockpile(s), crushed stockpiles(s) and product stockpile(s) with float measured as closing inventory tonnes (mass).

Similarly, for an underground metalliferous mine, Model B may model the flow of ore from the drawpoint to various stockpile locations or ore passes or vertical clearance onto crushed stocks prior to processing. In an underground metals case, the movement of waste and or from the face to the final surface or underground destination may be modelled in Model B.

As will be appreciated by those skilled in the art, each model 100, 110 may be defined in computer-executable instructions (software), thereby providing flexibility for potentially changing or altering the models 100, 110. Each model 100, 110 may also include a model storage database, a results storage database, and an application programming interface (API), which may define functional access (e.g., through function calls and the like) to each model 100, 110 as well as model builder logic and model deployment logic. Each model 100, 110 may further include user interface logic and resource allocation logic. Each model 100, 110 may further include or be coupled to a processor or compute engine, and/or an historical data storage databases.

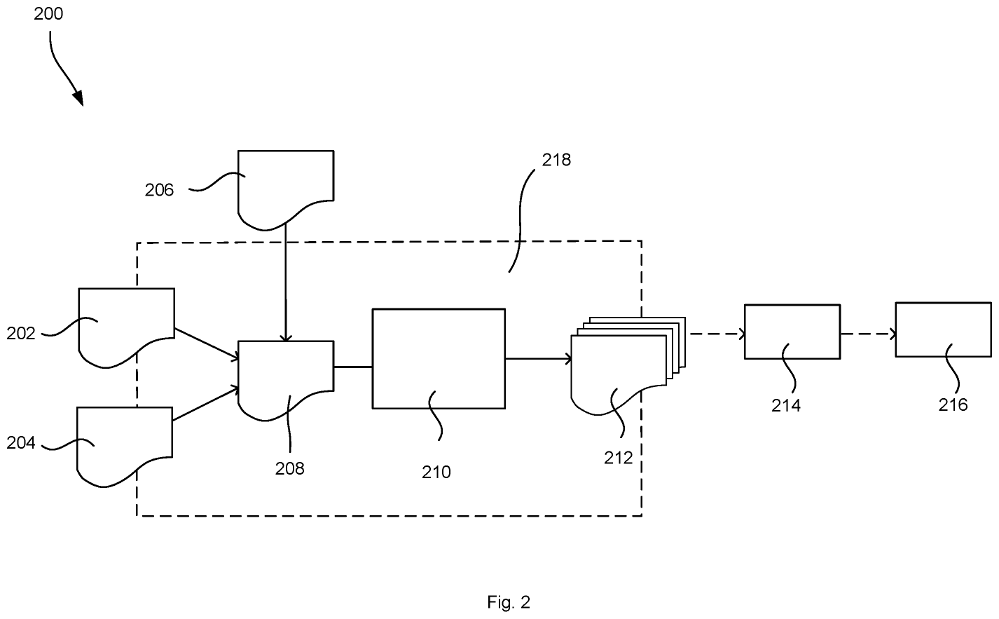

FIG. 2 shows a simplified block diagram of a system for determining the robustness of a mine plan 200 according to an embodiment of the present invention. A mine plan 202, an activity map 204 and distributions 206 to be applied to groups of tasks, or work packages, within the mine plan 202 are configured for use and input to a stochastic simulation module 218 running on a processor or compute engine. In one or more embodiments, the stochastic simulation module 218 pulls together the distributions 206 and a replication module 210 to run Monte Carlo trails 208 to vary the inputs and calculate a float 214 for each work package. The float 214 for each work package is input to a float banding logic module 216 where it is ultimately displayed to a user. The float banding logic module 216 consolidates the floats from each simulation 212 into a robustness index, which is ultimately displayed to a user via a graphical user interface (GUI) on a display of a computer. The GUI includes parameter controls, which allow a user to dynamically adjust how the float is rendered. For example, a first level of output may give a user a summary of the robustness of the mine plan 202 as calculated by the system 200. That summary may be represented as a table showing a high-level view of the mine plans 202 robustness. A subsequent level of output may provide a deeper and richer view of results, for example, raw results, charts or heatmaps showing the impact of variance on closing inventory or the like.

In one or more embodiments, the float banding logic module 216 consolidates the calculated float into bands allowing the presentation of a very simple mine plan robustness index. The language used to define the bands may be aligned with risk consequence, for example, minor, moderate and major risk. In another embodiment, the float may be displayed as an integer.

The mine plan 202 includes one or more tasks required to perform operations in a mine and are generally deterministic in nature using single point assumptions and inputs resulting in a single output. A typical input to the mine plan 202 is a geological model; generally, in such models, geological resources are represented as blocks or strips i.e., a regular-spaced grid of blocks. A block is typically a prismatic shape that is represented by some coordinates e.g., (x,y,z). These models contain most of the necessary information for planning. For instance, rock alteration, mineralisation zones, rock densities and element concentrations are fundamental in defining the value of the mine. Mine planners, with the help of other professional disciplines, are responsible for transforming geological resources to ore reserves. However, this is largely beyond the scope of the present disclosure, as the system 200 does not seek to re-sequence or re-optimise the mine plan 202 but rather presents a view on mine plan robustness given the impact of variance.

As an example, the mine plan 202 will take a task such as truck shovel waste removal for a block or strip and determine how long it will take to complete mining that task. In one or more embodiments, the mine plan 202 is based on three key scheduling inputs: task, rate, and time. It will be appreciated that in a single mine plan 202 there may be thousands of individual tasks. Each task may be given a unique identifier, for example, <Location><Activity><Resource><DesignClass><Start Date>. The unique identifier allows for the allocation of variance. For example, seam thickness distribution may vary by seam and rate may vary by resource. The start date is required to complete the unique identifier as the work is not always continuous and there are period and others breaks within a task. It will also be appreciated that the mine plan 202 is not limited to the above identifiers and each identifier may have separate levels. For example, at one level the location may be broadly defined as a particular mine, at another level the location may be more narrowly defined as a particular section of that mine.

In some embodiments of the invention, tasks are grouped into work packages of related tasks, such that variance can be applied efficiently and the system 200 may operate quickly (or in substantially real-time) on relatively low-end hardware that is, for example, constrained by processor speed and memory.

A skilled person will readily identify proprietary software solutions adapted to create a mine plan within the mining process and the general format of the output, for example, each task may be defined in a well-formed XML or CSV file defined by a XML or CSV schema. An XML or CSV schema defines the structure of a file, its fields, valid values and ranges for fields etc.

The activity map 204 aligns mining activities, scheduled and unscheduled, to locations at a mine site. Separate activity maps 204 may need to be populated according to various embodiments of the present invention. As discussed with reference to FIG. 1a, for Model A, the mine plan 202 is based on tasks ordered sequentially (in open cut mines, this is generally from top to bottom stratigraphically). As discussed with reference to FIG. 1b, for Model B, the mine plan 202 is based on quantities being sequenced to produce a final product.

The Model A activity map 204 is required to identify the processes that occur at the mine site. These include both scheduled and unscheduled tasks. The activity map 204 lists the tasks in sequential order and is supported by a defined location level such as geological stratigraphy as well as the individual tasks required for each horizon (e.g., H15 overburden requires dozer prep, drilling, blasting, waste removal and the like). Identifying unscheduled tasks is part of this mapping (e.g., support or ancillary functions) and these are managed as windows of time and space (WOTS). The activity map 204 includes the rules for the unscheduled tasks that are either calculated based on a rate (e.g., tonnes mined per location etc.) or a set duration.

The activity map 204 for Model B maps the ore process at the mine site within battery limits (e.g., mine to product stockpile), it also identifies the rules used in the mine plan 202. These rules may include identifying how parcels of ore are treated on a stockpile (e.g., feed stockpile—separate parcels (PDM), first on first off, qualities of stockpiles averaged etc.), location rules (e.g., no south ramps coal are fed to CVM) and inputs and outputs (e.g., rejects are output from the feeder breaker).

A skilled person will readily identify proprietary software solutions adapted to generate an activity map 204 within the mining process and the general format of the output, the structure of a file, its fields, valid values and ranges for fields etc.

In general, the activity map 204 provides configuration management for each model. Model configuration is specific and must be tailored to each implementation (i.e. at a different mine). A user will generally derive an activity map 204 with their knowledge and understanding of any mine plan 202 rules put in place and entering data associated with those rules (e.g., unscheduled task locations and rates for Model A and product quality limits for Model B).

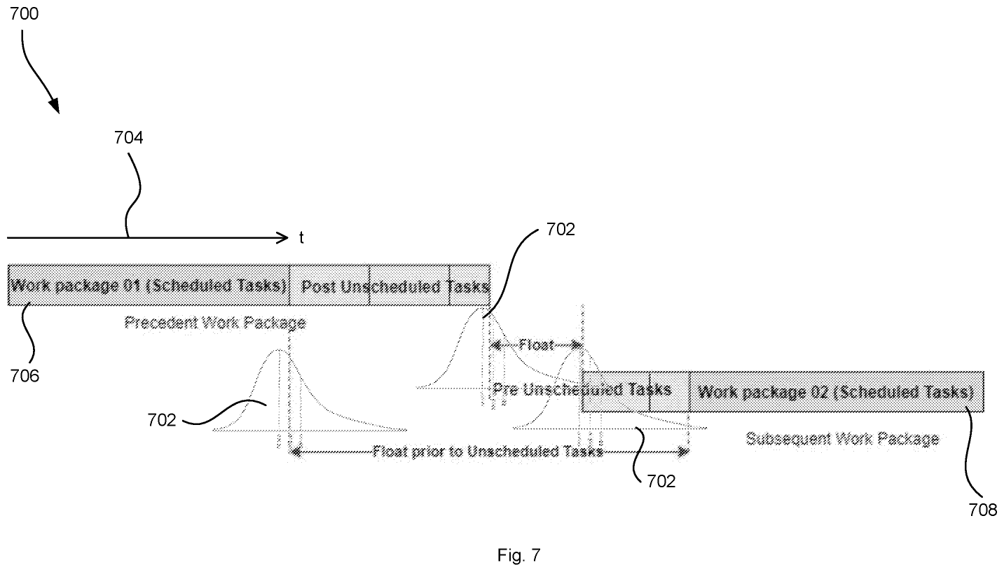

In one or more embodiments, each task in the mine plan 202 is grouped into one or more work packages, grouping the tasks into work packages ensures that the plan replication (as discussed with reference to FIG. 6) and variance (as discussed with reference to FIG. 7) occur at an appropriate level so that the resulting variance reflects the most valuable level of detail for assessing robustness.

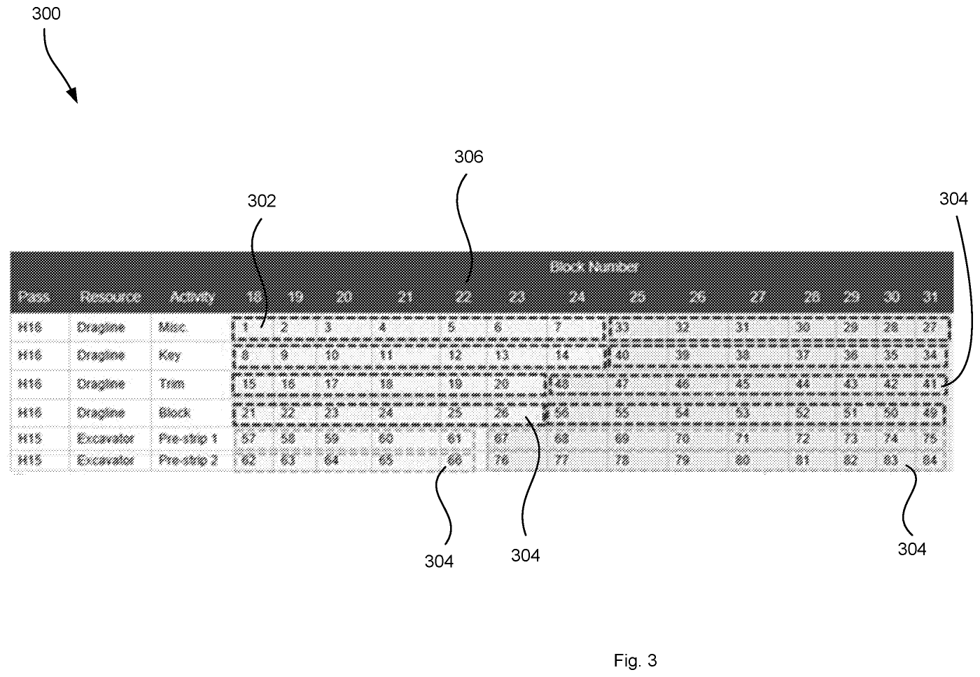

Work packages will be discussed in greater detail with reference to FIG. 3, however, in simple terms, each scheduled task is attributed to a work package. The work packages reflect a chunk of work done as a whole on the mine site and the tasks within a work package share features pre-configured by the user. Work packages have zero or more precedent work packages associated, reflecting the mine site sequencing constraints.

The system 200 then replicates the mine plan 202 thousands of times with varied inputs to rate, time and task based on the individual mine sites historical rates and time as well as relevant task variations (e.g. geological variances, level of design and reconciliations). The system 200 then measures the variance in float and inventory of each simulated mine plan 212 and uses ‘float’ bands to measure both positive and negative variations, where ‘float’ in this instance is both float (time) and inventory (tonnes). The system 200 does not re-optimise or re-schedule based on the varied input, but measures the float at all key interfaces and ore inventory from every simulated replication 212.

FIG. 3 shows a grouping 300 of scheduled tasks 302 into work packages 304 in accordance with an embodiment of the present invention. Work packages 304 are a grouping of scheduled tasks 302 that share the same resource, location or process (e.g. Work package 1=H16 Dragline task 1-26 and Work package 2=H16 Dragline task 27-56). Float is then calculated between work packages (i.e., representing the spare time between a process or resource interaction). For example, a whole pre-strip pass worth of blocks 306 removed by a common excavator is packaged together, and the float is calculated based on whether that pass is done in time for the next pass to start.

In one or more embodiments, the work package logic is based on the differences between two consecutive tasks for the same resource. Consecutive tasks sharing common features may be configured by users by way of a GUI. These features may include, by default: ‘resource unit’, a work package can only include one of equipment; ‘location levels’, the change in certain location levels can trigger the creation of a new work package. For example, if a dragline changes ramp, a new work package is created. However, if a dragline changes block, this doesn't trigger the creation of a new work package; and, ‘activity levels’, likewise, the user can decide that a change in activity creates a new work package.

In addition, the user can configure time-based rules that consecutive tasks need to follow. For example, two consecutive tasks with a time lag bigger than a day will not be aggregated to the same work package. Time-based rules allow for ramp split identification (as in the example above, between WP 1->26 and 33->49).

In one or more embodiments, each work package is given a unique identifier, for example:

<ResourceUnit> (non-configurable)
<LocationLevel1><LocationLevel2><...><Location Level>
<ActivityLevel1><ActivityLevel2>
<StartTime>

A skilled person will readily identify suitable schemas for providing for providing the stated function, for example, each work group may be defined by an XML schema or similar.

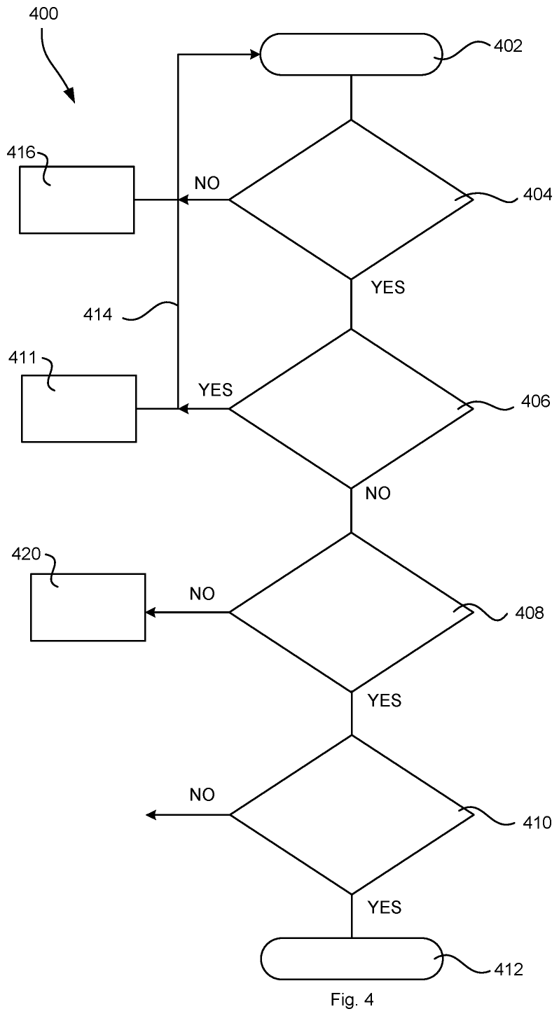

FIG. 4 shows a method 400 for determining an appropriate work package in accordance with an embodiment of the present invention. It will be appreciated that the method 400 may be defined by computer-executable instructions, including code executable by a processor to determine the appropriate grouping of tasks into workgroups.

The method starts at start block 402 to determine whether a candidate work package definition is appropriate. At decision block 404 it is determined whether important process and resource interactions occur between different work packages the majority of the time. If no, the definition is likely too fine grain to be considered an appropriate work package for the variance module and consolidation may be recommended to the user at 416, or the method will return over 414. If yes, the method continues to decision block 406. At decision block 406 it is determined whether there are any important process and resource interactions that occur within the work package. If yes, then definition is likely too coarse to be considered an appropriate work package for the variance module and splitting up may be recommended to the user at 418, or the method will return over 414. If no, the method continues to decision block 408. At decision block 408, it is determined whether the variance being applied to the schedule is expected to be applied consistently across the tasks within the work package. If no, the definition is likely at the correct granularity (based on decisions 404 and 406), and the user is prompted that care should be taken when replicating the schedule to ensure variance is applied appropriately (i.e., varied at a sub-work package or task level before consolidation to work package level) at 420 and the method continues to decision block 410. If yes, the method also continues to decision block 410. At decision block 410 the user may determine from the reporting of calculated floats (either time or inventory) whether it is useful to pivot, filter or group by the differentiating features of each work package (e.g., ramp, strip, block, process-step, month, resource, material type). If no, then it may be that further work package consolidation can be conducted because the granularity is more fine grain than desired, in this instance manual intervention may be required. If yes, the work package definition is adequate and the method ends at end block 412.

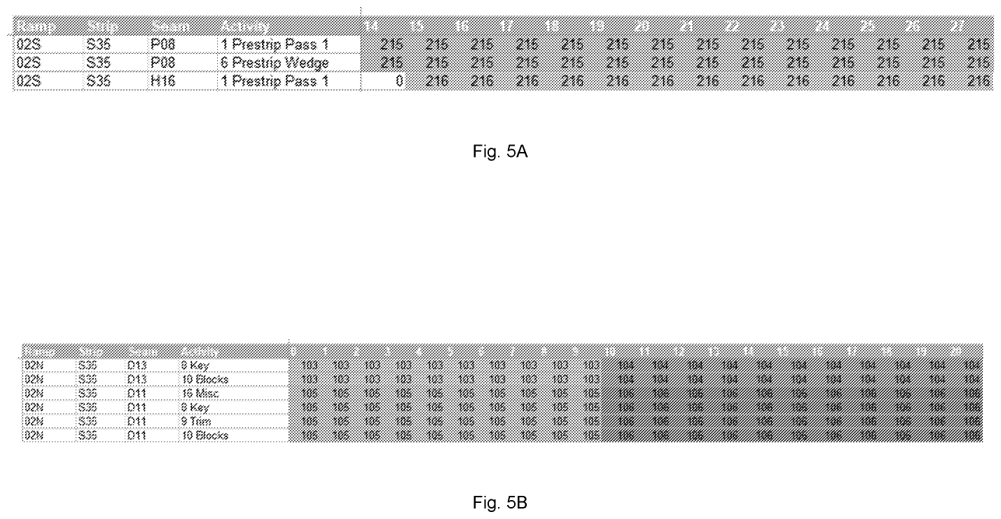

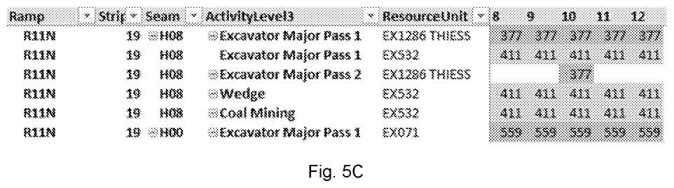

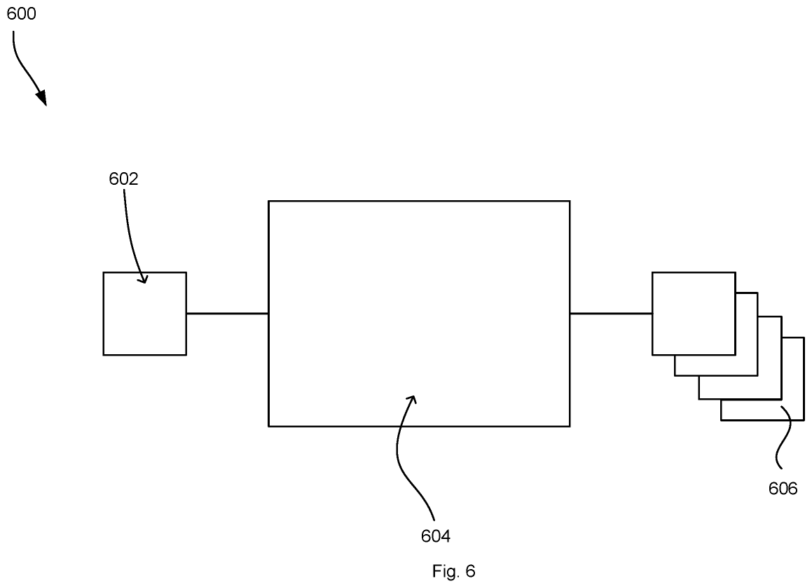

FIGS. 5a to 5c show examples of work packages in accordance with an embodiment of the present invention. It will be appreciated that a user may select, manage, and display tasks and work packages relevant to their preference by way of a user interface. Moreover, it will be appreciated that tasks, blocks, work packages etc. can be displayed in a table format that includes one or more columns, each column comprising field values of a block field, and each column having a column heading comprising a different one of the block fields. The table may also include one or more rows, each row comprising one or more of the field values, each field value in a row associated with a different activity or the like. Cells in the table can be emphasized to indicate they are part of the same work package or similar. Those skilled in the art will recognise suitable designs for providing the stated functions.

In FIG. 5a, work package 215 includes Prestrip pass 1 and Prestrip wedge for ramp 02S, Strip 35, Seam P08 and block 14 to 27. Work package 216 is on a different seam and therefore is a different work package from the one above.

Work package 215 is the precedent of 216 as 215 needs to happen before 216. The float will be the time difference between the start of 216 and the end of 215, including any unscheduled tasks in between the two work packages.

In FIG. 5b, the ramp/strip/seam is split in two block groups, one from block 0 to 9 (WP 103 and 105), and the other from block 10 to 20 (WP 104 and 106).

WP 103 is the precedent of 105 as WP 103 can only happen after 105 is done (but is not impacted by the completion of 104). Likewise, 104 is the precedent of 106.

In FIG. 5c two resources are working on the same location. As the work is done by two distinct resources, two different work packages are triggered, as illustrated above. 377 is done by EX1286 (Pass 1 and Pass 2) on R11N. S19, H08 from block 8 to 12 and 411 is done at the same location (Pass 1, wedge and coal mining) by EX32.

In this case, WP 559 which is done on the seam above, has two precedents as it needs both WP 377 and WP 411 to be completed before starting.

The outcomes from the work packaging process gives the user the ability to visualise the work packages per location, process and resource.

Each scheduled task will have an associated work package. Through grouping, filtering and pivoting of the schedule (including the work package number).

FIG. 6 shows a replication module 600 that forms part of a robustness assessment system in accordance with an embodiment of the present invention. The replication module 600 can be considered a core module of the system 200, with reference to FIG. 2. The replication module 600 requires inputs 602 to be preconfigured. The inputs 602 may include an activity map, a mine plan, and work packages. These inputs 602 are discussed with reference to FIG. 2 and FIG. 3, respectively.

The replicated mine plan is equivalent to the original mine plan at a work package level. Each of the varied inputs 602 can be controlled programmatically so that Monte Carlo simulation can automatically replicate as many plans as needed. Since the number of trials and work packages can be fairly high, this can result in a large number. For example, a mine plan model with 200 work packages and 5000 simulation will mean the stochastic simulation output will be 200×5000=1,000,000 rows of data.

In one or more embodiments, the replication module 600 keeps the list of tasks, their resourcing and their sequence fixed. This way the replication module 600 does not optimise the plan, rather it recreates a known set of scheduled tasks. Advantageously, compared to known scheduling tools, the system does not need to apply the same constraints or calculations. For example, making sure the resource is only in the one place at the one time, making sure blocks are completed before moving on, making sure only one product is being generated at a time.

Accordingly, the replication module 600 is very fast, it can replicate a mine plan so that Monte Carlo simulation is able to run in a reasonable amount of time (e.g., a fraction of a second). In some embodiments, the simulation is a multiple core, multiple thread simulation, for faster parallel execution. In other embodiments, the simulator is run on a single core computer for single thread execution.

The purpose of the variance module, which will be discussed in greater detail with reference to FIG. 7, is to assess the impact of known variance on a given mine plan or schedule.

The output 606 of the replication module 600 may be list of floats (either time or inventory, depending on the model used) for each work package in the plan. This output 606 serves as the core back-end data format for the float banding logic module. It will be appreciated that a user interface may be provided for viewing the replicated mine plan as a table and may include statistical functions, and export to comma separated variable (CSV), and access to a raw export tool or the like. The user interface may allow users to compare how close each replica is to the original mine plan. For example, if they are identical then the underlying model is acting as intended. If they are different, then it may be that an assumption or rule is wrong. The user can use this functionality to find where the differences are and judge their importance. Those skilled in the art will recognise suitable user interface designs for providing the stated functions.

As used herein, the expression “Monte Carlo” shall be broadly construed to refer to the generic act of sampling in probabilistic simulation and is not meant to preclude of other variants of sampling in probabilistic simulation, such as Latin hypercube, and Sobol sampling, importance sampling or any variance reduction techniques commonly employed with or as a substitute for traditional Monte Carlo sampling.

FIG. 7 shows a diagram 700 of variance 702 associated with a duration of time 704 being applied between work packages 706, 708. The variance 702 is expressed as a probability density function. However, it will be appreciated that the variance may also be expressed as a cumulative distribution function or a similar probability-related function. As discussed above, the variance may be derived from a variety of data sources (i.e., historical and expert elicitation). Considerations include source and reliability of data, units of measure, sampling frequency, drivers of variance (such as location, sub-task, equipment, etc.), applicable scope of the distribution (e.g., mine, seam, block) and the correlation between distributions.

In one or more embodiments, distributions are loaded from proprietary geoscience and geostatistics software packages. In another form of the invention, distributions may be fit by a statistician based on an expert probability elicitation workshop to develop best-guess distributions in lieu of data (e.g., based on loss and dilution). The distribution used for the stochastic modelling directly impacts the results from the stochastic modelling, and in turn the robustness index. For example, the robustness index will be impacted if the distributions are fit using unreliable data, incorrect data, fit using an inappropriate type of theoretical distribution, and the like. In some embodiments, the type of statistical filling may be limited to a small number of simple distributions to avoid problems with poor data.

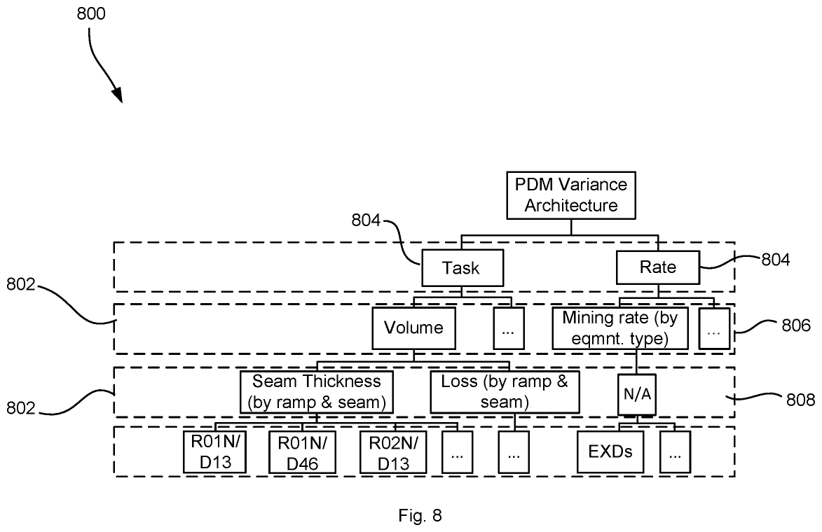

FIG. 8 shows a cause tree 800 which illustrates how a user may view or select what elements of the variance architecture will be included in the stochastic simulation.

In one or more embodiments, users can choose what variance causes 802 will be included in the model by source 804 (e.g., task, rate or time) and by driver (e.g., activity, resource, location) so that the stochastic modelling can model the impact of those variances. This is determined by a variance architecture module. The variance architecture determines which distributions are required to be configured for use within the stochastic simulation. It maps three variance sources (task, rate, and time) to variance causes that are broken into sub-levels which can be thought of as variance driver trees.

At the second most bottom level of the cause tree 808, a replication variable is selected which dictates which replication parameter to vary for that particular cause. This is how the stochastic simulation knows to link distributions to the replication model when running Monte Carlo trials.

At the bottom most level of a particular variance cause tree 806, the cause is given a task ‘dimensionality’ or ‘grouping’ that reflects the drivers of that variance cause (e.g. by seam or by resource class). This is used to dictate how many distributions will be required for the particular mine plan being assessed based on the task nomenclature (<Location><Activity><Resource><Start Date>) as described above. For example, as shown, the Seam Thickness variance cause is marked as being driven “by ramp and seam” which corresponds to the task nomenclature ‘Location’. This is how a user may determine that a seam thickness distribution should be configured for each ramp and seam combinations that exist.

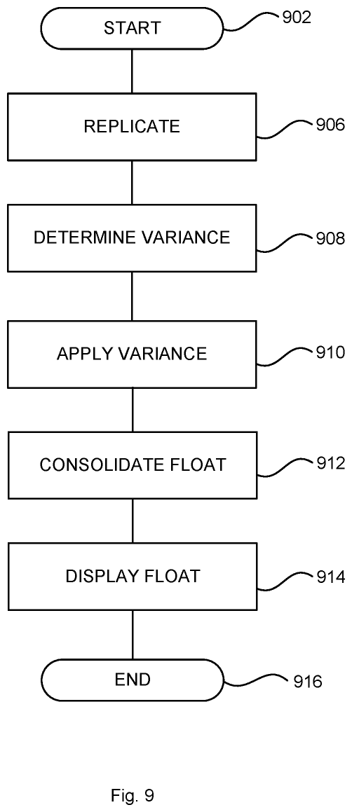

FIG. 9 is a flow chart of a method carried out on a processor for determining the robustness of a mine plan 900 in accordance with an embodiment of the present invention.

Processing begins at start block 902 where a mine plan is received by the processor from a user via an input device, which is coupled to the processor via a storage device, e.g., a hard drive, a network accessible storage device etc. The process continues at process block 904 where the mine plan including one or more tasks required to perform operations in a mine is replicated such that stochastic modelling can be undertaken. The mine plan may be replicated thousands of times by the processor. The process continues at process block 906, where the tasks are grouped into work packages, each work packaged being associated with a duration of time.

The process continues at process block 908, where a variance associated with the duration of time is determined. The variance may be in the form of a probability density function imported from a separate process, for example, from another software application or package. At process block 910 the variance determined at process block 908 is applied based on at least one simulation to generate a float. In this instance, the float is the duration of time between the completion of a precedent work package and/or the commencement of a subsequent work package. However, in other forms of the invention, the float may be the inventory mass moved between one or more nodes in the mine.

The process continues at process block 912, where each float is consolidated into a robustness index and displayed to the user at process block 914. Processing ends at end block 916.

As discussed above, the various embodiments can be implemented in a wide variety of operating environments, which in some cases can include one or more user computers, computing devices, or processing devices which can be used to operate any of a number of applications. User or client devices can include any of a number of general purpose personal computers, such as desktop or laptop computers running a standard operating system, as well as cellular, wireless, and handheld devices running mobile software and capable of supporting a number of networking and messaging protocols. Such a system also can include a number of workstations running any of a variety of commercially-available operating systems and other known applications for purposes such as development and database management. These devices also can include other electronic devices, such as dummy terminals, thin-clients, gaming systems, and other devices capable of communicating via a network.

Various aspects also can be implemented as part of at least one service or Web service, such as can be part of a service-oriented architecture. Services such as Web services can communicate using any appropriate type of messaging, such as by using messages in extensible markup language (XML) format and exchanged using an appropriate protocol such as SOAP (derived from the “Simple Object Access Protocol”). Processes provided or executed by such services can be written in any appropriate language, such as the Web Services Description Language (WSDL). Using a language such as WSDL allows for functionality such as the automated generation of client-side code in various SOAP frameworks.

Some embodiments may utilize at least one network that would be familiar to those skilled in the art for supporting communications using any of a variety of commercially-available protocols, such as TCP/IP, OSI, FTP, UPnP, NFS, and CIFS. The network can be, for example, a local area network, a wide-area network, a virtual private network, the Internet, an intranet, an extranet, a public switched telephone network, an infrared network, a wireless network, and any suitable combination thereof.

The environment can include a variety of data stores and other memory and storage media as discussed above. These can reside in a variety of locations, such as on a storage medium local to (and/or resident in) one or more of the computers or remote from any or all of the computers across the network. In a particular set of embodiments, the information can reside in a storage-area network (“SAN”) familiar to those skilled in the art. Similarly, any necessary files for performing the functions attributed to the computers, servers, or other network devices can be stored locally and/or remotely, as appropriate. Where a system includes computerized devices, each such device can include hardware elements that can be electrically coupled via a bus, the elements including, for example, at least one central processing unit (CPU), at least one input device (e.g., a mouse, keyboard, controller, touch screen, or keypad), and at least one output device (e.g., a display device, printer, or speaker). Such a system can also include one or more storage devices, such as disk drives, optical storage devices, and solid-state storage devices such as random access memory (“RAM”) or read-only memory (“ROM”), as well as removable media devices, memory cards, flash cards, etc.

Such devices also can include a computer-readable storage media reader, a communications device (e.g., a modem, a network card (wireless or wired), an infrared communication device, etc.), and working memory as described above. The computer-readable storage media reader can be connected with, or configured to receive, a computer-readable storage medium, representing remote, local, fixed, and/or removable storage devices as well as storage media for temporarily and/or more permanently containing, storing, transmitting, and retrieving computer-readable information. The system and various devices also typically will include a number of software applications, modules, services, or other elements located within at least one working memory device, including an operating system and application programs, such as a client application or Web browser. It should be appreciated that alternate embodiments can have numerous variations from that described above. For example, customized hardware might also be used and/or particular elements might be implemented in hardware, software (including portable software, such as applets), or both. Further, connection to other computing devices such as network input/output devices can be employed.

Storage media and computer readable media for containing code, or portions of code, can include any appropriate media known or used in the art, including storage media and communication media, such as but not limited to volatile and non-volatile, removable and non-removable media implemented in any method or technology for storage and/or transmission of information such as computer readable instructions, data structures, program modules, or other data, including RAM, ROM, EEPROM, flash memory or other memory technology, CD-ROM, digital versatile disk (DVD) or other optical storage, magnetic cassettes, magnetic tape, magnetic disk storage or other magnetic storage devices, or any other medium which can be used to store the desired information and which can be accessed by a system device.

Embodiments of the present disclosure can be provided as a computer program product including a non-transitory machine-readable storage medium having stored thereon instructions (in compressed or uncompressed form) that can be used to program a computer (or other electronic device) to perform processes or methods described herein. The machine-readable storage medium can include, but is not limited to, hard drives, floppy diskettes, optical disks, CD-ROMs, DVDs, read-only memories (ROMs), random access memories (RAMs), EPROMs, EEPROMs, flash memory, magnetic or optical cards, solid-state memory devices, or other types of media/machine-readable medium suitable for storing electronic instructions. Further, embodiments can also be provided as a computer program product including a transitory machine-readable signal (in compressed or uncompressed form). Examples of machine-readable signals, whether modulated using a carrier or not, include, but are not limited to, signals that a computer system or machine hosting or running a computer program can be configured to access, including signals downloaded through the Internet or other networks. For example, distribution of software can be via Internet download.

Where the terms “comprise”, “comprises”, “comprised” or “comprising” are used in this specification (including the claims) they are to be interpreted as specifying the presence of the stated features, integers, steps or components, but not precluding the presence of one or more other features, integers, steps or components, or group thereof.

While the invention has been described in conjunction with a limited number of embodiments, it will be appreciated by those skilled in the art that many alternative, modifications and variations in light of the foregoing description are possible. Accordingly, the present invention is intended to embrace all such alternative, modifications and variations as may fall within the spirit and scope of the invention as disclosed.

1. A computer implemented method for determining the robustness of a mine plan, the method comprising computer program code instructions, being executable by a computer for:
replicating a mine plan, the mine plan including one or more tasks required to perform operations in a mine;
grouping the one or more tasks into one or more work packages, each work package being associated with a duration of time;
determining, for the one or more work packages, a variance associated with the duration of time;
applying the variance based on at least one simulation to generate a float, the float being the duration of time between the completion of a precedent work package and/or the commencement of a subsequent work package;
consolidating each float from the at least one simulation into a robustness index; and
displaying at least a portion of the robustness index to a user via a graphical user interface.

2. The method of claim 1, wherein the at least one simulation includes at least one of a discrete event simulation, dynamic simulation, or Monte Carlo simulation.

3. The method of claim 1, wherein the variance is derived from at least one of historical data, geostatistical data, geostatistical data from a geological model, reconciliation data, or input by the user.

4. The method of claim 1, wherein the variance is expressed as a probability density function.

5. The method of claim 1, wherein grouping the one or more tasks into one or more work packages is based on at least one of a common resource, location, or process in the mine.

6. The method of claim 1, further comprising the step of including one or more unscheduled tasks between the precedent and/or subsequent work packages.

7. The method of claim 6, wherein the float is the duration of time between the completion of a precedent work package and the commencement of a subsequent work package less the duration of time of the one or more unscheduled tasks.

8. The method of claim 1, wherein at least a portion of the float is displayed to the user as a band representing at least one of minor, moderate, or major risk associated with the execution of the mine plan.

9. The method of claim 1, wherein the float is displayed to the user as an integer.

10. A system for determining the robustness of a mine plan, the system comprising:
a processor configured to at least:
replicate a mine plan, the mine plan including one or more tasks required to perform operations in a mine;
group the one or more tasks into one or more work packages, each work package being associated with a duration of time;
determine, for the one or more work packages, a variance associated with the duration of time;
apply the variance based on at least one simulation to generate a float, the float being the duration of time between the completion of a precedent work package and/or the commencement of a subsequent work package;
consolidate each float from the at least one simulation into a robustness index; and
display at least a portion of the robustness index to a user via a graphical user interface.

11. The system of claim 10, wherein the at least one simulation includes at least one of a discrete event simulation, dynamic simulation, or Monte Carlo simulation.

12. The system of claim 10, wherein the variance is derived from at least one of historical data, geostatistical data, geostatistical data from a geological model, reconciliation data, or input by the user.

13. The system of claim 10, wherein the variance is expressed as a probability density function.

14. The system of claim 10, wherein the processor groups the tasks into one or more work packages based on at least one of a common resource, location, or process in the mine.

15. The system of claim 10, wherein the processor includes unscheduled tasks between the precedent and subsequent work packages.

16. The system of claim 15, wherein the float is the duration of time between the completion of a precedent work package and the commencement of a subsequent work package less the duration of the one or more unscheduled tasks.

17. The system of claim 10, wherein at least a portion of the float is displayed to the user as a band representing at least one of minor, moderate, or major risk associated with the execution of the mine plan.

18. The system of claim 10, wherein the float is displayed to the user as an integer.

19. A computer implemented method for determining the robustness of a mine plan, the method comprising computer program code instructions, being executable by a computer for:
replicating a mine plan, the mine plan including a set of tasks required to perform operations in a mine;
parsing the mine plan into one or more activities involving the movement of an inventory mass between one or more nodes in the mine;
determining, for one or more activities, a variance associated with one or more of the quality, quantity, rate and time;
apply the variance based on at least one simulation to generate a float, the float being the inventory mass between the nodes;
consolidating each float from the at least one simulation into a robustness index; and
displaying at least a portion of the robustness index to a user via a graphical user interface.

20. The method of claim 19, wherein the at least one simulation includes at least one of a discrete event simulation, dynamic simulation, or Monte Carlo simulation.

21. The method of claim 19, wherein the variance is derived from at least one of historical data, geostatistical data, geostatistical data from a geological model, reconciliation data, or input by the user.

22. The method of claim 19, wherein the variance is expressed as a probability density function.

23. The method of claim 19, wherein the float is displayed to the user as a band representing at least one of minor, moderate, or major risk associated with the execution of the mine plan.

24. The method of claim 19, wherein the float is displayed to the user as an integer.

25. A system for determining the robustness of a mine plan, the system comprising:
a processor configured to at least:
replicate a mine plan, the mine plan including a set of tasks required to perform operations in a mine;
process the mine plan into one or more activities involving the movement of an inventory mass between one or more nodes in the mine;
determine, for one or more activities, a variance associated with one or more of the quality, quantity, rate and time;
apply the variance based on at least one simulation to generate a float, the float being the inventory mass between the nodes;
consolidate each float from the at least one simulation into a robustness index; and
display at least a portion of the robustness index to a user via a graphical user interface.

26. The system of claim 25, wherein the at least one simulation includes at least one of a discrete event simulation, dynamic simulation, or Monte Carlo simulation.

27. The system of claim 25, wherein the variance is derived from at least one of historical data, geostatistical data, geostatistical data from a geological model, reconciliation data, or input by the user.

28. The system of claim 25, wherein the variance is expressed as a probability density function.

29. The system of claim 25, wherein the float is displayed to the user as a band representing at least one of minor, moderate, or major risk associated with the execution of the mine plan.

30. The system of claim 25, wherein the float is displayed to the user as an integer.
